(19) United States
(12) Patent Application Publication
(10) Pub. No.: US 2008/0093107 A1
(43) Pub. Date: Apr. 24, 2008

(54) Fire Resistant Cable

(76) Inventors: Pascal Amigouet, Boissy Saint Yon (FR); Jerome Fournier, Lyon (FR); Faiza Bergaya, Cyr en Val (FR); Jean Marc Clavier, Mehun Sur Yedre (FR); Anne Gaelle Le Cam, Ecully (FR); Philippe Johanis, Lyon (FR); Philippe Bras Pereira, Lyon (FR)

Correspondence Address: SOFER & HAROUN LLP., 317 MADISON AVENUE, SUITE 910, NEW YORK, NY, 10017, US

(21) Appl. No.: 11/579,826

(22) PCT Filed: May 20, 2005
(86) PCT No.: PCT/EP05/10042

§ 371 Date: Jul. 2, 2007

(30) Foreign Application Priority Data
May 21, 2004 (FR) 04/05508
Oct. 1, 2004 (FR) 04/52238

(51) Int. Cl. H01B 7/29; H01B 3/00

(52) U.S. Cl. 174/121 A

(57) ABSTRACT

The present invention relates to a cable comprising at least one conductor element extending inside at least one insulating covering. The invention is remarkable in that at least one insulating covering is made from a fire-resistant composition comprising a polymer and a fibrous phyllosilicate.

The present invention relates to a cable capable of withstanding extreme temperature conditions.

The invention finds a particularly advantageous, but non-exclusive application in the field of power or telecommunications cables that are to remain operational for a defined length of time when they are subjected to high temperatures and/or directly to flames.

Nowadays, one of the major issues in the cable-making industry lies in improving the behavior and the performance of cables under extreme temperature conditions, and in particular those that are to be encountered during a fire. Essentially for safety reasons, it is essential to maximize the ability of a cable to retard flame propagation and also to withstand fire. A significant slowdown in the progress of flames constitutes a corresponding increase in time available for evacuating premises and/or for deploying appropriate fire-extinguishing means. Better fire resistance makes it possible for a cable to continue operating longer since it degrades more slowly. A safety cable must also not be dangerous for its environment, i.e. it must not give off smoke that is toxic and/or too opaque on being subjected to extreme temperature conditions.

Regardless of whether a cable is electrical or optical, for carrying power or transmitting data, it is constituted in outline by at least one conductor element extending inside at least one insulating element. It should be observed that at least one of the insulating elements may also act as protective means and/or that the cable may also include at least one specific protective element constituting a sheath. It is known that amongst the best insulating and/or protective materials used in cable-making, many of them are unfortunately also highly flammable materials. This applies in particular to polyolefins and their copolymers, such as, for example: polyethylene, polypropylene, ethylene and vinyl acetate copolymers, an ethylene and propylene copolymers. In any event, in practice, such excessive flammability is totally incompatible with the above-mentioned requirements for withstanding fire.

In the field of cable-making, there are numerous methods for improving the fire behavior of the polymers used as insulating and/or sheathing materials.

The solution that has been in the most widespread use until now consists in using halogenated compounds, in the form of a halogenated by-product dispersed in a polymer matrix, or directly in the form of a halogenated polymer, such as polyvinyl chloride (PVC), for example. Nevertheless, present regulations are tending to ban the use of substances of that type, essentially because of their potential toxicity and corrosiveness, whether at the time of material manufacture, or in the event of decomposition in a fire. This is particularly true when the decomposition in question might be taking place accidentally in a fire, but also in the event of it taking place voluntarily, during incineration. In any event, recycling halogenated materials continues to remain particularly problematic.

That is why more and more use is being made of non-halogenated fire-retardant fillers, and in particular of metallic hydroxides such as aluminum hydroxide or magnesium hydroxide. That type of technical solution nevertheless presents the drawback of requiring large quantities of filler in order to achieve a satisfactory level of effectiveness, whether in terms of retarding flame propagation or in terms of fire resistance. By way of example, the metallic hydroxide content can typically reach 50% to 70% of the total composition of a material. Unfortunately, any massive incorporation of filler leads to a considerable increase in the viscosity of the material, and consequently to a significant decrease in extrusion speeds, thus leading to a large drop in productivity. Adding excessive quantities of fire-retardant additives also lies behind a significant deterioration in the mechanical and electrical properties of a cable.

In order to remedy those difficulties, it is now known to use as insulating and/or sheathing materials nanocomposites in the form of an organic matrix having dispersed therein inorganic particles of a size that is well below one micrometer. In this respect, associating a polymer type organic phase with a clay-based inorganic phase presenting a flake structure gives results that are satisfactory in terms of withstanding fire.

Nevertheless, preparing nanocomposites of that type requires the clay filler to be subjected to prior treatment in order to give it properties that are as organophilic as possible. The idea is to make it easier for polymer chains to penetrate between and take up positions between the flakes of clay. In the state of the art, there are numerous ways of performing such surface treatment. But whatever the technique used, it nevertheless remains that this unavoidable additional step is particularly disadvantageous in terms of the cost price of the final insulating and/or sheathing material. Furthermore, in order to be effective, the clay flakes must be exfoliated, i.e. separated from one another, and distributed uniformly within the polymer matrix. It is difficult to achieve good exfoliation with industrial plastics processing equipment.

Thus, the technical problem to be solved by the subject matter of the present invention is to propose a cable comprising at least one conductor element extending within at least one insulating covering, which cable makes it possible to avoid the problems of the prior art by being in particular significantly less expensive to fabricate, while offering mechanical, electrical, and fire-resistant properties that are preserved.

According to the present invention, the solution to the technical problem posed consists in that at least one insulating covering or at least one sheath is made from a fire-resistant composition comprising a polymer and a fibrous phyllosilicate.

It should be emphasized that the concept of a conductor element is used herein to cover both a conductor of electricity and a conductor of light. Thus the invention can relate equally well to an electrical cable or to an optical cable, and regardless of whether the cable is for conveying power or transmitting data.

As their name suggests, fibrous phyllosilicates have a microscopic structure in the form of fibers. This is a considerable difference relative to the clay fillers used in the prior art which generally present a structure in the form of aggregates at microscopic scale and a lamellar structure in the form of flakes at nanoscopic scale. In any event, the particular physicochemical structure of fibrous phyllosilicates give them properties that are specific thereto: a large form factor, very high porosity and specific area, large absorption capacity, low ionic capacity, and high thermal stability.

It should be observed that when dispersed in a polymer matrix, a fibrous phyllosilicate cannot be considered as being a nanofiller, i.e. a filler in which the particles are of nanometer size. The dimensions of the fibers constituting it are for the most part much greater than a nanometer, as confirmed by the fact that the dimensions of fibrous phyllosilicates are commonly expressed in micrometers in the state of the art.

In any event, a composition in accordance with the invention provides fire behavior that is entirely satisfactory, and in any event compatible with using this type of material for insulating and/or sheathing a cable. Adding a fibrous phyllosilicate significantly improves the fire behavior of the polymer material, both in terms of non-propagation of flames, and in terms of fire resistance.

Compared with prior art clay-based fillers, a fibrous phyllosilicate also presents the advantage of being suitable for use without prior surface treatment, and in particular without the essential and expensive prior art treatment for making it organophilic.

According to a feature of the invention, the fibrous phyllosilicate of the fire-resistant composition is selected from sepiolite, palygorskite, attapulgite, kalifersite, loughlinite, and falcondoite, and is preferably sepiolite. Nevertheless, it should be observed that in the literature, palygorskite and attapulgite are often considered as being the same phyllosilicate.

The particular physicochemical structure of sepiolite gives it properties that are specific thereto: very high porosity and specific area, large absorption capacity, low ionic capacity, and high thermal stability.

In particularly advantageous manner, the fire-resistant composition is provided with less than 60 parts by weight of fibrous phyllosilicate, preferably sepiolite, per 100 parts by weight of polymer.

Preferably, the fire-resistant composition includes 5 to 30 parts by weight of fibrous phyllosilicate, preferably sepiolite, per 100 parts by weight of polymer.

According to another feature of the invention, the polymer of the fire-resistant composition is selected from: a polyethylene; a polypropylene; an ethylene and propylene copolymer (EPR); an ethylene, propylene, diene terpolymer (EPDM); an ethylene and vinyl acetate copolymer (EVA); an ethylene and methyl acrylate copolymer (EMA); an ethylene and ethylene acrylate copolymer (EEA); an ethylene and butyl acrylate copolymer (EBA); an ethylene and octene copolymer; an ethylene-based polymer; a propylene-based polymer; or any mixture of said ingredients.

In particularly advantageous manner, the fire-resistant composition contains at least one polymer grafted with a polar compound such as a maleic anhydride, a silane, or an epoxy, for example.

In accordance with another advantageous characteristic of the invention, the fire-resistant composition includes at least one copolymer fabricated from at least one polar monomer.

According to another feature of the invention, the fire-resistant composition is also provided with a secondary filler that is constituted by at least one compound selected from: metallic hydroxides; metallic oxides; metallic carbonates; talcs; kaolins; carbon blacks; silicas; silicates; borates; stannates; molybdates; graphites; phosphorus-based compounds; and halogenated flame-retardant agents.

It should be observed that in practice, and as can be seen clearly from the example described below, very good results in terms of ability to withstand fire are obtained in particular by combining a fibrous phyllosilicate with a secondary filler based on at least one metallic hydroxide.

In particularly advantageous manner, the content of the secondary filler is less than or equal to 1200 parts by weight per 100 parts by weight of polymer.

Preferably, the fire-resistant composition includes 150 to 200 parts by weight of secondary filler per 100 parts by weight of polymer.

According to another feature of the invention, the fire-resistant composition includes at least one additive selected from anti-oxidants, ultraviolet stabilizers, and lubricants.

Other characteristics and advantages of the present invention appear from the following description of examples; the examples are given by way of non-limiting illustration.

It should be observed that Examples I to V all relate to compositions for use as insulating and/or sheathing materials for cables. Furthermore, all of the quantities that appear in the various Tables 1 to 5 are expressed conventionally in parts by weight per one hundred parts of polymer.

### EXAMPLE I

Example I is intended more particularly to show up the effects of a fibrous phyllosilicate, specifically sepiolite, on the mechanical properties of materials that already present fire-resistant properties.

Table 1 lists the proportions of the various ingredients of four material samples. It also lists some of their mechanical properties such as breaking strength and elongation at break, and also the results of fire-resistance tests relating more particularly to the oxygen limit index and the formation of lighted droplets, if any. It should be observed that for all of the tests, the various samples of material were conventionally prepared in the form of test pieces.

TABLE 1

| | Sample 1 | Sample 2 | Sample 3 | Sample 4 |
|---|---|---|---|---|
| EVA | 55 | 55 | 55 | 55 |
| PE | 35 | 35 | 45 | 45 |
| Maleic anhydride | 10 | 10 | 0 | 0 |
| grafted PE | | | | |
| Aluminum hydroxide | 200 | 195 | 170 | 165 |
| Sepiolite | 0 | 5 | 0 | 5 |
| Anti-oxidant | 1 | 1 | 1 | 1 |
| Additives | 3 | 3 | 3 | 3 |
| Silane | 0 | 0 | 1 | 1 |
| Breaking strength (MPa) | 10 | 12 | 11 | 14 |
| Elongation at break (%) | 290 | 233 | 220 | 210 |
| Oxygen limit index | 35 | 35 | 31 | 31 |
| Formation of lighted | yes | no | yes | no |
| droplets | | | | |

It will firstly be observed that the organic matrices of these four samples were all constituted by a mixture of polymers, specifically ethylene vinyl acetate, polyethylene, and optionally maleic anhydride grafted polyethylene.

It should also be observed that the combined quantities of aluminum hydroxide and sepiolite were identical for samples 1 and 2 and also for samples 3 and 4, in order to be able to make comparisons with a constant quantity of flame-retardant fillers.

In any event, it can be seen that the presence of sepiolite serves to improve significantly the mechanical properties of the polymer materials. This is revealed by a significant increase in breaking strength and by a reduction to a greater or lesser extent in elongation at break.

However, and above all, the presence of sepiolite prevents lighted droplets forming, a phenomenon commonly referred to as dripping. In this respect, it should be observed that this particularly advantageous property is not obtained with all clays.

### EXAMPLE II

Example II serves to show up the impact of sepiolite on the fire-resistant properties of materials that are intrinsically already capable of withstanding extreme temperature conditions.

Table 2 gives the compositions of seven materials that have been subjected to a fire-resistance test typical in the field of cable making. For that purpose, the various samples of material were prepared in the form of sheaths, and the tests were performed directly on cables sheathed in that way.

The procedures for this test can be outlined as follows: each cable is bent into a U-shape and then secured on a vertical support panel of refractory material. The bottom portion of the cable is then subjected for 30 minutes to a flame, i.e. to a temperature lying in the range 800° C. to 970° C. For the first 15 minutes, impacts are applied every 5 minutes to the assembly constituted by the cable secured to its support panel. During the following 15 minutes, water is sprayed onto the first portion of the cable while impacts continue to be applied once every 5 minutes to the panel and cable assembly. During those 30 minutes, a voltage lying in the range 500 volts (V) to 1000 V is also applied to each conductor of the cable. The test is successful providing there is no electrical malfunction or breakdown.

TABLE 2

| | Smpl | Smpl | Smpl | Smpl | Smpl | Smpl | Smpl |
|---|---|---|---|---|---|---|---|
| | 5 | 6 | 7 | 8 | 9 | 10 | 11 |
| EVA | 55 | 55 | 55 | 55 | 55 | 55 | 55 |
| PE | 35 | 35 | 35 | 35 | 45 | 45 | 45 |
| Maleic anhydride | 10 | 10 | 10 | 10 | 0 | 0 | 0 |
| grafted PE | | | | | | | |
| Aluminum hydroxide | 200 | 0 | 180 | 180 | 200 | 180 | 180 |
| Magnesium hydroxide | 0 | 200 | 0 | 0 | 0 | 0 | 0 |
| Sepiolite | 0 | 0 | 20 | 0 | 0 | 20 | 0 |
| Zinc borate | 0 | 0 | 0 | 20 | 0 | 0 | 20 |
| Anti-oxidant | 1 | 1 | 1 | 1 | 1 | 1 | 1 |
| Additive | 3 | 3 | 3 | 3 | 3 | 3 | 3 |
| Silane | 0 | 0 | 0 | 0 | 1 | 1 | 1 |
| Fire test | fail | fail | pass | fail | fail | pass | fail |

The remarks that can be made concerning the composition of each polymer matrix and also concerning the total quantity of flame-retardant filler are identical to those made with respect to Example I.

Giving consideration more particularly to samples 5 to 8, it can be seen that the compositions containing conventional flame-retardant fillers only did not withstand the fire-resistance test, regardless of whether the composition was aluminum hydroxide (sample 5) or magnesium hydroxide (sample 6). The presence of zinc borate instead of sepiolite, i.e. an additive that is known for improving the cohesion of ash, likewise failed to pass the test (sample 8).

The results relating to samples 9 to 11 show that a composition in accordance with the invention (sample 10) is capable of passing the fire-resistance test, even when it has no compatibility agent such as maleic anhydride grafted polyethylene. In other words, that means that sepiolite also acts as a compatibilizing agent between the various polymers present in the composition. This is also confirmed by the improvement in mechanical properties shown up in the context of Example I.

Thus, only compositions containing sepiolite pass the fire-resistance test (samples 7 and 10). It is therefore clear that this fibrous phyllosilicate significantly improves the cohesion of ash during and after combustion. By its fibrous structure, sepiolite reinforces the combustion residue that forms at the surface of the material. This residue is thus capable firstly of constituting a physical barrier suitable for limiting the diffusion of any volatile compounds derived from degradation of the material, and also a thermal barrier capable of reducing the amount of heat that is transferred to said material.

### EXAMPLE III

Example III serves to show up the effects of sepiolite on the flame-retardant properties of materials that are intrinsically capable of withstanding extreme temperature conditions.

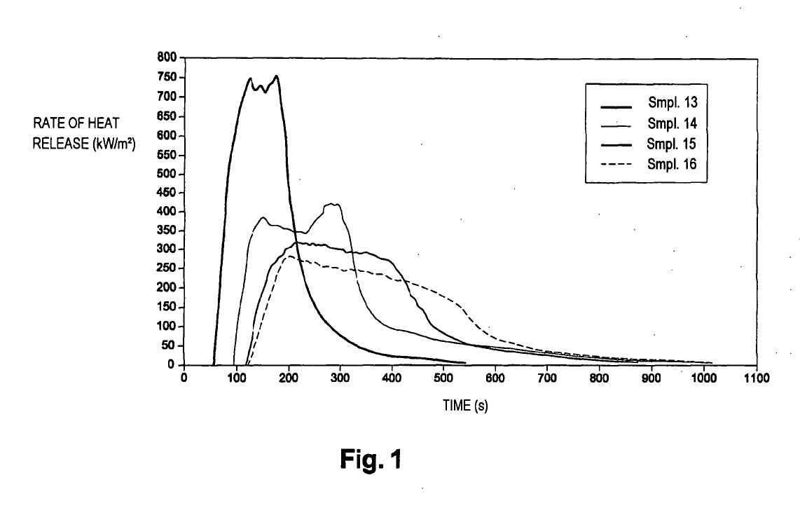

For this purpose, cone calorimeter analyses were performed. Specifically, the rate of heat release over time was measured during the combustion of five samples presenting increasing quantities of sepiolite. FIG. 1 shows the behaviors of the corresponding materials.

Table 3 lists the respective compositions of the various samples 12 to 16 that were tested, together with their main characteristics in terms of total heat release, mean rate of heat release, and maximum rate of heat release. It should be observed that the various characteristics mentioned in Table 3 are mean values, unlike the curves in FIG. 1 which were plotted using purely experimental measurements.

TABLE 3

| | Smpl | Smpl | Smpl | Smpl | Smpl |
|---|---|---|---|---|---|
| | 12 | 13 | 14 | 15 | 16 |
| PE | 100 | 100 | 100 | 100 | 100 |
| Sepiolite | 0 | 5 | 10 | 30 | 50 |
| Total heat release (MJ/m²) | 110 | 105.6 | 110.7 | 102.3 | 105 |
| Mean rate of heat release | 208 | 279 | 133 | 152 | 128 |
| (kW/m²) | | | | | |
| Maximum rate of heat | 803 | 784 | 426 | 320 | 283 |
| release (kW/m²) | | | | | |

Concerning the values listed in this table, it can be seen firstly that the total amount of heat released was practically constant, thus demonstrating that substantially the same quantity of polyethylene was indeed burnt in all of the tests.

It should also be observed that the combustion energy decreased significantly when sepiolite was added.

The maximum rate of heat release was already reduced when the sepiolite content was only 5 parts by weight per 100 parts by weight of polymer. This reduction became almost optimum with 30 parts by weight of sepiolite since that sufficed to reach a kind of pause; a content of 50 parts by weight in comparison produced variations that were not of any great note.

It can also be seen from the various curves of FIG. 1 that using sepiolite also serves to lengthen the time of combustion, which contributes advantageously to retarding the progress of a fire.

### EXAMPLE IV

Example IV relates to materials including palygorskite, and like Example III it serves to show up the flame-retardant properties of those materials.

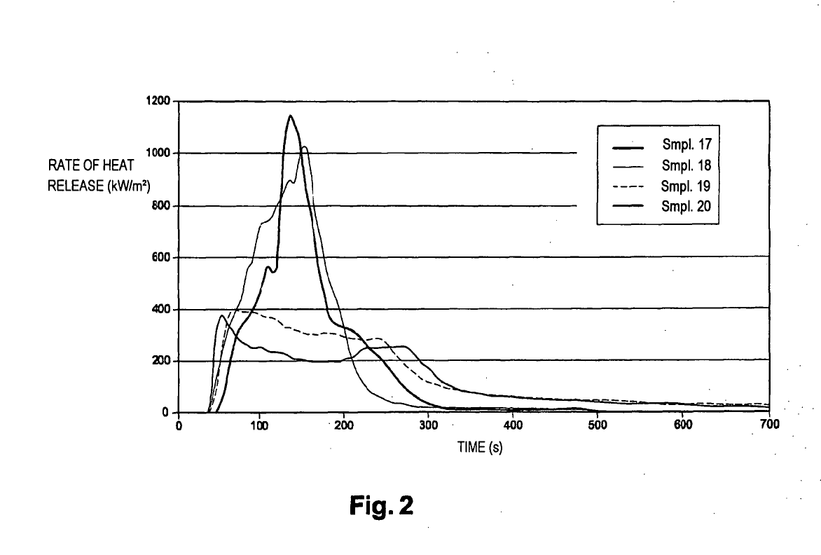

For this purpose, analyses were likewise undertaken by means of a cone calorimeter. However in this example the rate of heat release was measured over time during combustion of four samples presenting increasing quantities of palygorskite. FIG. 2 shows the behaviors of the corresponding materials.

Table 4 lists the respective compositions of the various samples 17 to 20, together with their main characteristics in terms of total heat release, mean rate of heat release, and maximum rate of heat release. It should be observed that like Table 3, the various characteristics mentioned in Table 4 are mean values, unlike the curves of FIG. 2 which were plotted using purely experimental results.

TABLE 4

| | Sample | Sample | Sample | Sample |
|---|---|---|---|---|
| | 17 | 18 | 19 | 20 |
| EVA | 100 | 100 | 100 | 100 |
| Palygorskite | 0 | 10 | 30 | 50 |
| Total heat release (MJ/m²) | 108 | 103 | 84 | 75 |
| Mean rate of heat release | 321 | 325 | 145 | 122 |
| (kW/m²) | | | | |
| Maximum rate of heat release | 1447 | 1025 | 401 | 366 |
| (kW/m²) | | | | |

Firstly, it can be seen that the combustion energy is significantly reduced when palygorskite is added. The maximum rate of heat release is already reduced when the content of palygorskite is only 10 parts by weight per 100 parts by weight of polymer. This reduction became practically optimum with 30 parts by weight of palygorskite since that sufficed to reach a kind of level; a content of 50 parts by weight in comparison did not provide any variations of real note.

It can also be seen from the various curves in FIG. 2, even if they are not as well-marked as in Example III, that the use of palygorskite also serves to lengthen the combustion times of the materials, in other words it serves advantageously to retard the progress of the fire.

In conclusion, it can clearly be seen that the presence of palygorskite serves to improve significantly the fire behavior of a polymer material.

### EXAMPLE V

Example V is for showing the incidence of adding a surfactant to compositions in accordance with the invention, on the mechanical properties and fire-resistance properties of materials made using said compositions.

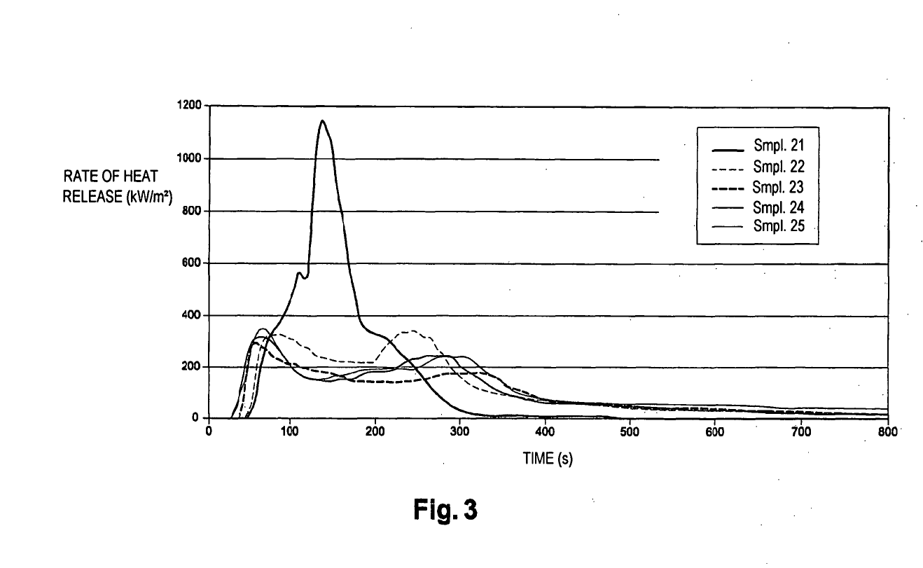

Table 5 lists the respective compositions of the various samples 21 to 25 tested. It also gives the mean values of measurements performed during cone calorimeter analyses in terms of total heat release, mean rate of heat release, and maximum rate of heat release. In this respect, FIG. 3 shows the behaviors of the corresponding materials. Table 5 finally lists the elongation at break values measured for each of the samples.

TABLE 5

| | Smpl | Smpl | Smpl | Smpl | Smpl |
|---|---|---|---|---|---|
| | 21 | 22 | 23 | 24 | 25 |
| EVA | 100 | 100 | 100 | 80 | 80 |
| Sepiolite | 0 | 50 | 0 | 50 | 0 |
| Palygorskite | 0 | 0 | 50 | 0 | 50 |
| Surfactant | 0 | 0 | 0 | 20 | 20 |
| Total heat release | 108 | 103 | 84 | 78 | 77 |
| (MJ/m²) | | | | | |
| Mean rate of heat | 321 | 325 | 145 | 116 | 113 |
| release (kW/m²) | | | | | |
| Maximum rate of heat | 1447 | 336 | 401 | 325 | 400 |
| release (kW/m²) | | | | | |
| Elongation at break (%) | 700 | 233 | 406 | 304 | 570 |

Firstly, it can be seen that the quantity of organic matrix was constant in all of the various compositions, thus making direct comparisons possible.

It should then be observed that the surfactant does not degrade in any way the fire-resistance properties of compositions based on fibrous phyllosilicates. Those properties continue to be much better than those of a standard composition as represented in this example by sample 21, which is fundamental in the context of the invention.

Finally, it should be observed that the presence of the surfactant serves to improve the mechanical properties compared with materials derived from compositions based solely on fibrous phyllosilicates (samples 22 and 23). In this respect, it should be observed that the most significant gain was obtained with palygorskite.

To conclude, it can clearly be seen that the presence of a fibrous phyllosilicate makes it possible to improve significantly the fire behavior of a polymer material. This type of compound presents the advantage in the event of the material burning of significantly increasing the cohesion of its ash and of eliminating problems of dripping. Finally, a composition based on a mixture of polymer and of fibrous phyllosilicate presents real capacities for withstanding fire and preventing flame propagation. These properties are also entirely compatible with insulation material type applications and/or sheathing power or telecommunications cables.

1. A cable comprising:
at least one conductor element extending inside at least one insulating covering, wherein at least one insulating covering is made from a fire-resistant composition having a polymer and a fibrous phyllosilicate.

2. A cable comprising:
at least one conductor element extending inside at least one insulating covering, wherein the cable also includes at least one protective sheath made from a fire-resistant composition having a polymer and a fibrous phyllosilicate.

3. A cable according to claim 1, wherein the fibrous phyllosilicate of the fire-resistant composition is selected from sepiolite, palygorskite, attapulgite, kalifersite, loughlinite, and falcondoite, and is preferably sepiolite.

4. A cable according to claim 1, wherein the fire-resistant composition includes less than 60 parts by weight of fibrous phyllosilicate, preferably sepiolite, per 100 parts by weight of polymer.

5. A cable according to claim 1, wherein the fire-resistant composition includes 5 to 30 parts by weight of fibrous phyllosilicate, preferably sepiolite, per 100 parts by weight of polymer.

6. A cable according to claim 1, wherein the polymer of the fire-resistant composition is selected from: a polyethylene; a polypropylene; an ethylene and propylene copolymer (EPR); an ethylene, propylene, diene terpolymer (EPDM); an ethylene and vinyl acetate copolymer (EVA); an ethylene and methyl acrylate copolymer (EMA); an ethylene and ethylene acrylate copolymer (EEA); an ethylene and butyl acrylate copolymer (EBA); an ethylene and octene copolymer; an ethylene-based polymer; a propylene-based polymer; or any mixture of said ingredients.

7. A cable according to claim 1, wherein the fire-resistant composition includes at least one polymer grafted with a polar compound.

8. A cable according to claim 1, wherein the fire-resistant composition includes at least one copolymer derived from at least one polar monomer.

9. A cable according to claim 1, wherein the fire-resistant composition includes a secondary filler having at least one compound selected from: metallic hydroxides; metallic oxides; metallic carbonates; talcs; kaolins; carbon blacks; silicas; silicates; borates; stannates; molybdates; graphites; phosphorus-based compounds; and halogenated flame-retardant agents.

10. A cable according to claim 9, wherein the fire-resistant composition includes less than 1200 parts by weight of secondary filler per 100 parts by weight of polymer.

11. A cable according to claim 9, wherein the fire-resistant composition includes 150 to 200 parts by weight of secondary filler per 100 parts by weight of polymer.

12. A cable according to claim 1, wherein the fire-resistant composition includes at least one additive selected from anti-oxidants, ultraviolet stabilizers, and lubricants.

13. A cable according to claim 2, wherein the fibrous phyllosilicate of the fire-resistant composition is selected from sepiolite, palygorskite, attapulgite, kalifersite, loughlinite, and falcondoite.

14. A cable according to claim 2, wherein the fire-resistant composition includes less than 60 parts by weight of fibrous phyllosilicate, preferably sepiolite, per 100 parts by weight of polymer.

15. A cable according to claim 2, wherein the fire-resistant composition includes 5 to 30 parts by weight of fibrous phyllosilicate, preferably sepiolite, per 100 parts by weight of polymer.

16. A cable according to claim 2, wherein the polymer of the fire-resistant composition is selected from: a polyethylene; a polypropylene; an ethylene and propylene copolymer (EPR); an ethylene, propylene, diene terpolymer (EPDM); an ethylene and vinyl acetate copolymer (EVA); an ethylene and methyl acrylate copolymer (EMA); an ethylene and ethylene acrylate copolymer (EEA); an ethylene and butyl acrylate copolymer (EBA); an ethylene and octene copolymer; an ethylene-based polymer; a propylene-based polymer; or any mixture of said ingredients.

17. A cable according to claim 2, wherein the fire-resistant composition includes at least one polymer grafted with a polar compound.

18. A cable according to claim 2, wherein the fire-resistant composition includes at least one copolymer derived from at least one polar monomer.

19. A cable according to claim 2, wherein the fire-resistant composition includes a secondary filler having at least one compound selected from: metallic hydroxides; metallic oxides; metallic carbonates; talcs; kaolins; carbon blacks; silicas; silicates; borates; stannates; molybdates; graphites; phosphorus-based compounds; and halogenated flame-retardant agents.

20. A cable according to claim 19, wherein the fire-resistant composition includes less than 1200 parts by weight of secondary filler per 100 parts by weight of polymer.

21. A cable according to claim 19, wherein the fire-resistant composition includes 150 to 200 parts by weight of secondary filler per 100 parts by weight of polymer.

22. A cable according to claim 2, wherein the fire-resistant composition includes at least one additive selected from anti-oxidants, ultraviolet stabilizers, and lubricants.
